(19) United States
(12) Patent Application Publication
(10) Pub. No.: US 2011/0054978 A1
(43) Pub. Date: Mar. 3, 2011

(54) METHOD AND SYSTEM FOR PROVIDING MARKETPLACE CALENDARING

(76) Inventor: Rakshat Singh Mohil, Lansing, MI (US)

(21) Appl. No.: 12/553,866

(22) Filed: Sep. 3, 2009

(51) Int. Cl. G06Q 10/00; G06Q 30/00; G06F 3/048; G06F 17/30; G06F 15/16

(52) U.S. Cl. 705/9; 715/738; 709/206; 707/E17.014; 705/27.1

(57) ABSTRACT

A method and server for providing an interactive calendar functionality within an online marketplace. The server includes a network interface. The server includes a memory for storing a merchant profile information. The server includes a processor in communication with the memory and the network interface. The processor is configured to, responsive to a customer query, provide the merchant profile information to a customer over the network interface, wherein the merchant profile information includes a merchant description, a set of available services, and an appointment availability. The processor is configured to, responsive to receiving a customer proposed appointment selected from the merchant profile information, forwarding the customer proposed appointment to a requested merchant over the network interface, wherein the customer proposed appointment includes an appointment time and a requested service. The processor is configured to, responsive to receiving a merchant acceptance, transmit a confirmation of an accepted appointment information to the customer and the merchant. The processor is configured to storing the accepted appointment information in the memory.

### BACKGROUND

Electronic commerce consists of the buying and selling of products or services over electronic systems such as the Internet and other computer networks. With regards to services, electronic commerce usually has a more geographically limited scope, linking up merchants with nearby customers. Various online marketplaces allow customers to search for nearby merchants for customer-specified services.

Online marketplaces can allow participating parties, such as merchants and customers, to rate each other with a feedback or review system. Systems can be made public or private and may be maintained internally by an individual (or a network) or externally. Such feedback can include a predefined satisfaction level, a comments section, and any other information relevant to describing a completed transaction.

A payment service provider processes electronic payments from a customer to a merchant. Payment can be sent by a variety of payment methods including credit card, bank-based payments such as direct debit, bank transfer, and real-time bank transfer based on online banking.

Calendar applications are time-management applications that track pending and past appointments. Additional functionality include automatically reminding a user of an upcoming appointment, allowing user-entered text to be associated with an appointment, visually depicting a user's schedule, etc.

All of the above approaches have shortcomings. Therefore, there is a need to provide an integrated online marketplace calendaring application.

### BRIEF DESCRIPTION OF DRAWINGS

The features and objects of the present disclosure will become more apparent with reference to the following description taken in conjunction with the accompanying drawings wherein like reference numerals denote like elements and in which:

FIG. 1 illustrates an example system for providing an online marketplace calendar.

FIG. 2A illustrates an example procedure for a server providing an online marketplace calendar.

FIG. 2B illustrates an example procedure for a customer requesting an appointment in an online marketplace calendar.

FIG. 3 illustrates an example server for providing an online marketplace calendar.

FIG. 4 illustrates an example workstation for providing an online marketplace calendar.

FIG. 5 illustrates an example mobile device for providing an online marketplace calendar.

FIG. 6A illustrates a first example screen shot of a website for providing an online marketplace calendar.

FIG. 6B illustrates a second example screen shot of a website for providing an online marketplace calendar.

FIG. 6C illustrates a third example screen shot of a website for providing an online marketplace calendar.

FIG. 6D illustrates a fourth example screen shot of a website for providing an online marketplace calendar.

FIG. 6E illustrates a fifth example screen shot of a website for providing an online marketplace calendar.

FIG. 6F illustrates a sixth example screen shot of a website for providing an online marketplace calendar.

FIG. 6G illustrates a seventh example screen shot of a website for providing an online marketplace calendar.

### DETAILED DESCRIPTION

A method and system provide an online marketplace with a plurality of merchants accessible to a plurality of customers. Customers can interact with merchant calendars to create a personalized service schedule. Customers can schedule appointments online at their leisure without needing to call during business hours or engaging in unnecessary negotiation. Relevant information for a potential customer is made available online. In addition, a customer feedback and rating system help cultivate an ethical business environment while helping both merchants and customers better manage and build long-term relationships.

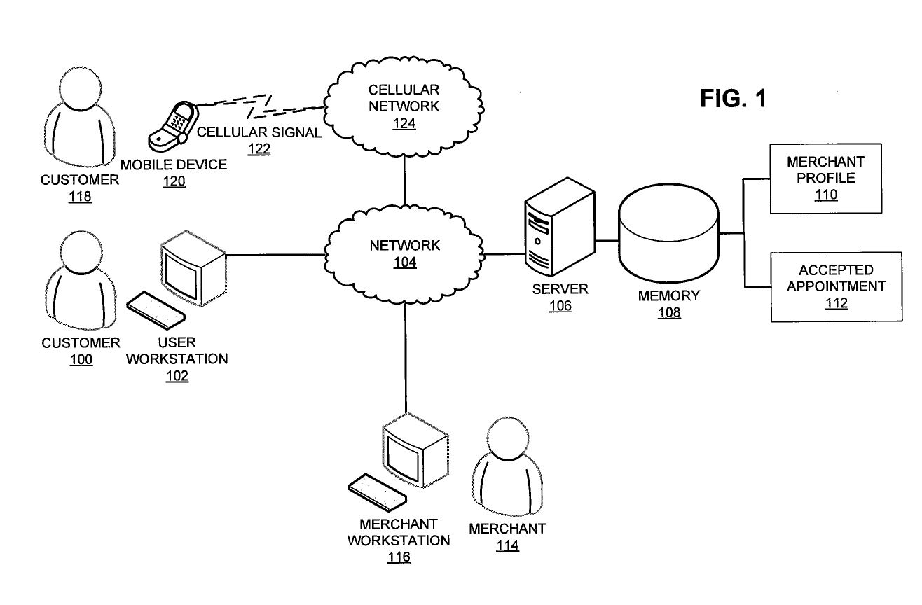

FIG. 1 illustrates an example system for providing an online marketplace calendar. A customer 100 can access a user workstation 102 in communication with a network 104 to access a server 106.

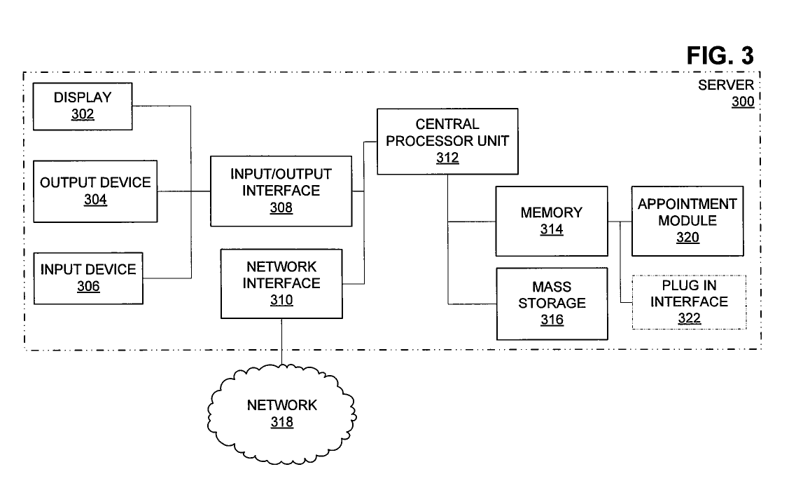

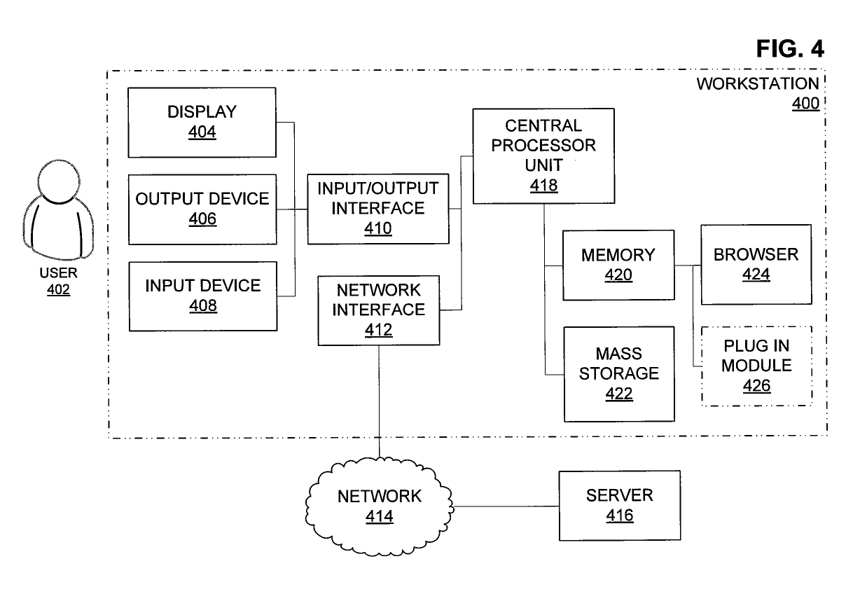

For example, the user workstation 102 can be a workstation as illustrated in FIG. 4. The network 104 can be a network configured to carry digital information, for example, the Internet. The server 106 can be as illustrated in FIG. 3.

The server 106 is in communication with a computer-readable memory 108. The memory 108 stores at least one merchant profile 110 and any accepted appointments 112. It will be appreciated that while only one merchant profile and accepted appointment is illustrated, any number of either can be stored in the memory 108.

A merchant 114 can use a merchant workstation 116 to access the server 106 over the network 104. The merchant workstation 116 can be similar to the user workstation 102, but accessible to the merchant 114.

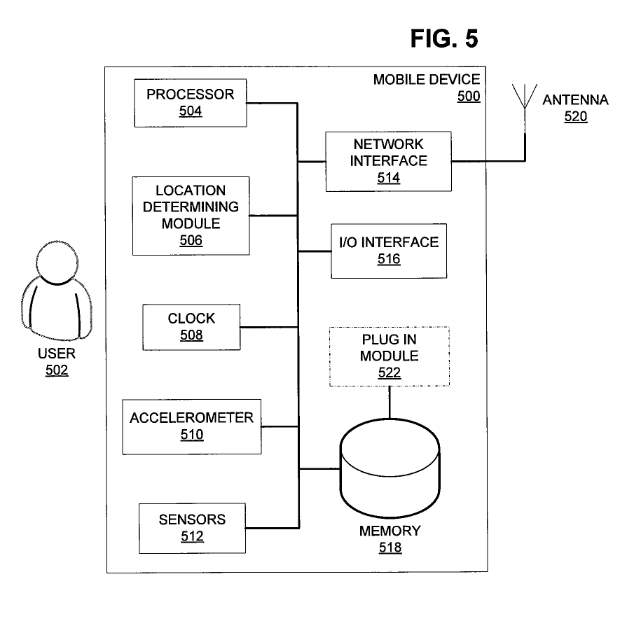

A customer 118 can use a mobile device 120 which communicates via cellular signals 122 with a cellular network 124. The mobile device 120 can be as illustrated in FIG. 5 and communicate with the server 106. The cellular network 124 can communicate with the network 104 through various conventional interfaces.

The above system can provide an online marketplace allowing customers to interface with various merchants. Each merchant is associated with a merchant profile, including an availability calendar and a set of services provided. A customer can request appointments and services online via the user workstation 102 or from the mobile device 120 at his convenience. The system can provide a rating system based on previous customer feedback that cultivates an ethical business environment while helping both merchants and customers better manage and build long-term relationships.

The merchant 114 gains access to an alternative client base (marketplace) and a business pipeline that is convenient and easy to use. Furthermore, merchants can improve their reputation within the marketplace via customer feedback. The feedback-driven scoring system offers the ability to draw in new business and foster positive relations with existing customers. Moreover, the online marketplace improves merchant efficiencies in scheduling, marketing and managing ongoing customer relationships.

All parties in the online marketplace benefit from efficient time management made possible by the calendar tool. Merchants periodically update their profile information, including the availability calendar and offered services. Customers search for desired services by keyword, location, merchant type, date, time, etc. Merchants matching the search criteria are displayed along with their profile and ratings. Customers can then request an appointment based on the merchant's availability.

The merchant 114 can accept the customer proposed appointment, after which the server 106 sends a confirmation to all parties. Alternatively, the merchant 114 can offer an alternative appointment or otherwise communicate with the customer.

The customer can also have an associated profile. Both the merchant and customer profiles can specify when reminder SMS or emails should be sent. In addition, the profiles can include an emergency contact number so that the customer or the merchant can provide timely updates in case of changes or cancellations. In one embodiment, the online marketplace can suggest alternative merchants or customers in case of a cancellation.

In one embodiment, the customer negotiates a price with the merchant 114 before or after the appointment is confirmed. Alternatively, the customer can accept a price posted by the merchant in the merchant profile information. The online marketplace can receive a referral fee from the customer, the merchant, or some combination of the two for each successful appointment.

Upon completion of the services, the online marketplace can request feedback from the customer and the merchant based on a quick survey. The customer can also provide additional detail on services received, thus building up a history of each merchant on the online marketplace.

In one embodiment, the online marketplace can provide a single payment solution to the customers and merchants, allowing for better interchange rate and single statement functionality.

In one embodiment, the stored accepted appointments 112 can be analyzed for additional cross-selling and up-selling opportunities for the customer.

In one embodiment, the merchant 114 can alternatively access the network 104 via a mobile device such as a PDA, a hand held device, etc.

It will be appreciated that while only two customers are illustrated, any number of customers can access the server over any number of networks to search for merchants and request appointments.

It will be appreciated that while only one merchant is illustrated, any number of merchants can access the server over any number of networks to approve requested appointments.

It will be appreciated that while only one server is illustrated, any number of servers can be provided within the system, for example, in a geographically distributed manner, to provide redundancy and improve system response times.

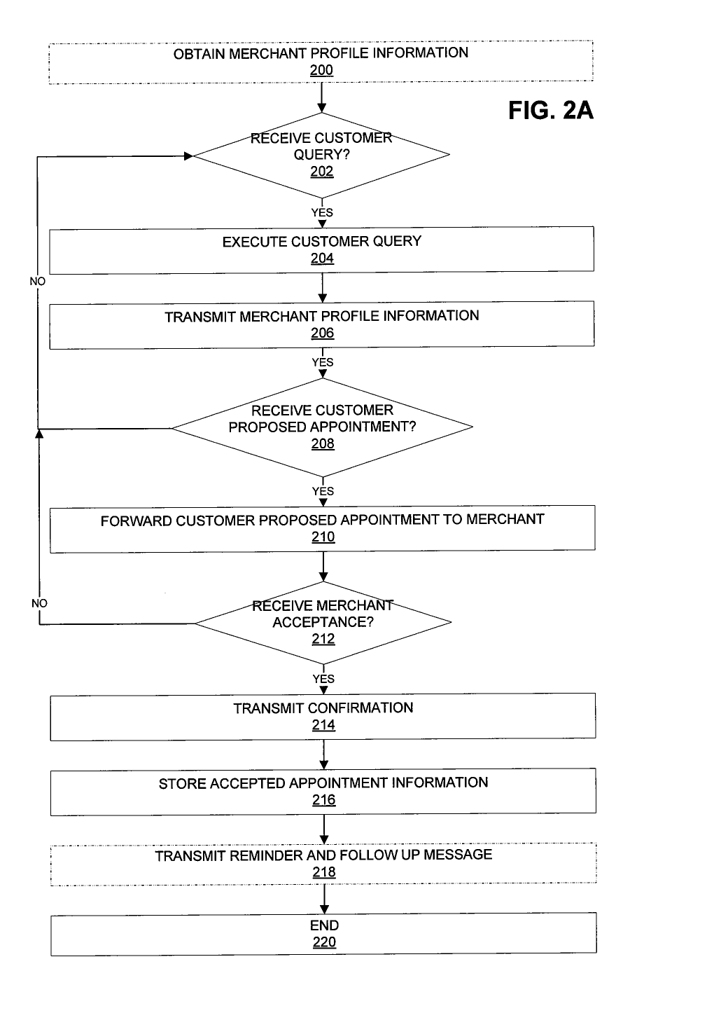

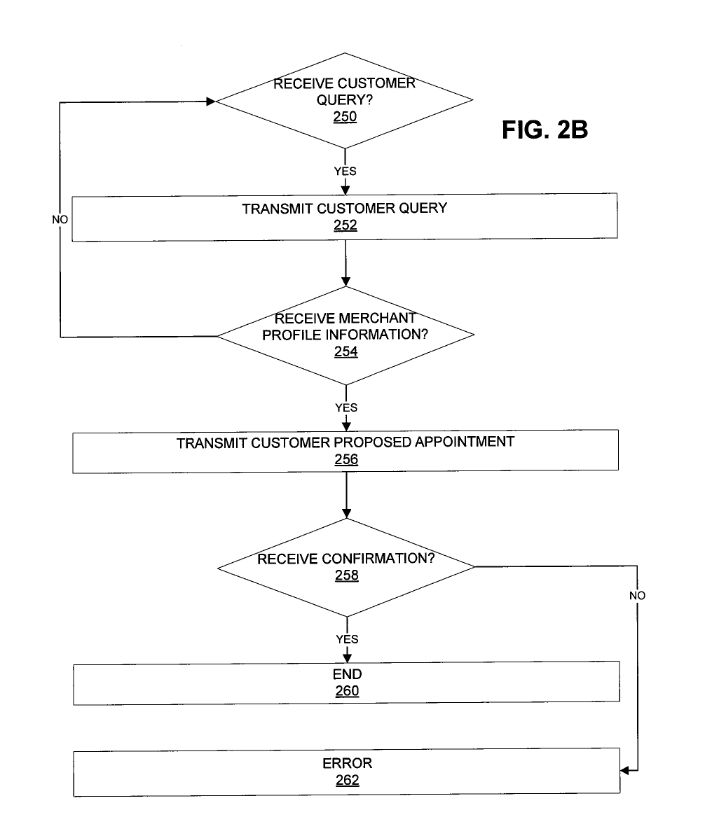

FIG. 2A illustrates an example procedure for a server providing an online marketplace calendar. For example, the procedure can execute on a server as illustrated in FIG. 3 within a system as illustrated in FIG. 1.

In 200, the server optionally obtains the merchant profile information. In one embodiment, merchants log in and update their personal profile and availability calendar. For example, the availability calendar can automatically synchronize with the merchants individual or proprietary calendaring systems.

In another embodiment, the merchant profile information can be gathered from online search engine results and online directories. Such profiles can be claimed by the associated merchant by having the merchant create an account.

In another embodiment, the merchant profile information can be retrieved from an internal database, for example, purchased, word of mouth, subscriptions, marketed merchants, etc.

In 202, the server can test whether a customer query has been received. Customers can log in and search for a merchant on a centralized location by different metrics (zip, merchant name, merchant category, type, date, time, reviews, telephone area codes, merchant addresses, prices, picture, videos, carbon credits, environmentally consciousness, carbon neutral, green solutions, energy efficiency, etc.) If yes, the server proceeds to 204 with the customer query. If no, the server can wait at 202 for the customer query.

The customer can be associated with a customer account and a customer profile. The online marketplace will be able to store personal information, previous searches and proposed customer appointments, online notes, etc. with any pending appointments.

In 204, the server can execute the received customer query and generate a search result list. The search result list can include one or more merchants that satisfy the above customer query. Each merchant can be associated with merchant profile information, including services offered, an availability calendar, and customer feedback for prior transactions.

In 206, the server can transmit a merchant profile information to the customer for customer review. The merchant profile information can be displayed for the customer at a workstation or a mobile device.

In 208, the server can test whether a customer proposed appointment is received. Once the customer has found a suitable merchant, he can propose an appointment. If a customer proposed appointment is received, the server proceeds to 210. If no, the server returns to 202 to await a next customer query.

In 210, the server forwards the customer proposed appointment to the selected merchant. For example, the merchant can be contacted via email, automated phone calls, SMS messages, pagers, facsimile or any other communication channel.

In 212, the server tests whether a merchant acceptance has been received. The merchant can either accept the invite or counter the invite with an alternative appointment. Alternatively, the merchant can request more information from the customer regarding the requested service to better schedule the appointment or provide a price estimate.

If the merchant acceptance is received, the server proceeds to 214. If not, the server transmits an error message to the customer and returns to 202.

In 214, the server transmits a confirmation to both the customer and the merchant. For example, the confirmation can include an appointment event that can be imported into individual calendar applications by the customer and the merchant. Example calendar applications include Blackberry Calendar, Microsoft Outlook, Lotus Notes, Gmail Calendar, Yahoo Calendar, etc. The merchant's availability calendar can be automatically updated by the server to reflect the confirmed appointment.

In 216, the server stores the accepted appointment information in an accessible memory. The stored accepted appointment information can later be used for data mining and analysis.

In 218, the server optionally transmits a reminder message to the customer and merchant. A reminder email or SMS is sent to both the merchant and the customer. Alternatively, the reminder message can be sent by other communication channels, such as an automated phone call, a post card, etc.

The server also optionally analyzes stored accepted appointment information for additional cross-selling and up-selling opportunities and transmits a follow up message. A customer history of prior appointments can be analyzed to make future recommendations to customers. For example, reminders can be sent regarding oil change due in 30 days or roof maintenance due in 1.5 years or dental appointment due in 90 days. Reminders can also be sent to merchants, such as which restaurants are being frequented within a specified zip code.

In another embodiment, the online marketplace can provide project manager functionality. For example, a customer can purchase lawn mowing services in the summers and therefore qualify for discounted snow removal services based on a customer zip code. In another example, a customer elects to waterproof his basement. The project manager option will automatically indicate the different activities in a sequence of events and recommend service providers in the correct sequence of activities, for example, basement drying service providers, plumbing service providers, landscaping service providers, dry wall service providers, tile service providers and the painters. Also as a result of interdependencies between different services (e.g. basement, dry walling, plumbing, tiling), if one service is pushed back or moved up, the interdependent services/appointments are automatically updated.

In another embodiment, the site functions as ‘one stop’ site for all due diligence/administrative/legal/insurance coverage paperwork. For example, merchants can house their information and be verified with the site for insurance requirements, tax forms, workers comp insurance, liability coverage, etc. The site thus functions as a ‘single storing and housing system’ for the merchant's administrative needs. The customer or potential client can get all necessary due diligence information from the site and the merchant can avoid redundant administrative paperwork with every new client.

In one embodiment, the site can partner with Major Retail Merchants (MRM) cross sell where the prices of the goods and services (hour rates) are reflected both itemized and as a bundled up package. In one example, Best Buy provides Price of HDTV and Hourly rate of having the HDTV installed. In another example, Home Depot provides Cost of Fire Place and Hourly rate of having the Fire Place installed.

In one embodiment, the online marketplace can help consumers plan their expenses based on their profile or needs (e.g. furnace or roof replacement reminder, update appliances, or in cases where a trend of frequent maintenance is detected, provide a suitable diagnostic recommendation).

In another embodiment, the online marketplace can provide personal assistant functionality. For example, a customer needs to run some errands. The personal assistant functionality can compute an optimal way to complete the errands in a time- and distance-optimized manner. The personal assistant functionality can also provide an optimizer based on price, urgency level, customer's needs, etc. to help prioritize services selected in a ‘Shopping Cart’ prior to confirming an appointment.

In another embodiment, the site can capture communication failures, for example, with an invalid merchant email address or if the merchant does not respond. The site can recommend an alternative merchant to the customer. Also the site can ask the customer to identify 2^{nd} or 3^{rd} choice as a back-up option when selecting a merchant.

In another example, the user history can be used to make future recommendations for the ‘shopping cart’, for example, upcoming birthdays, anniversaries, appointments, etc. This permits local vendors to advertise their services, such as birthday cards, flowers, gifts, etc. and share specials, promos coupons etc.

In another example, the customer can input criteria for a next appointment. This allows the user to schedule a future appointment, for example, to replace snow tires on a car or have a boat moved to storage before winter, etc. In another example, the user can search for discount offers based on discount/price e.g. curtains (seamstress offers discounts or specials during a particular month or season)

In 220, the server can exit the procedure.

In one embodiment, the merchant and the customer can communicate before a first appointment to generate an initial estimate based on the requested services and any information provided by the customer. The online marketplace can provide a merchant contact information, or a message interface allowing the customer to directly communicate with the merchant. Also it can allow for photo sharing (e.g. photo of a hole in the roof or an accident car needing body work) or a video sharing (e.g. a link to a video file of the merchant introducing himself or the customer walking through their issues or requirement).

Upon completion of the requested service, the customer can rate the merchant, ensuring that good work is rewarded within the online marketplace. The goal is to increase efficiencies on all levels for both the customer and the merchant while creating a robust marketplace. The customer can also “make a recommendation” to a friend/colleague and the merchant will receive notice that his business has been recommended. The customers will have the option to recommend a list of merchants or share their favorite merchants with other on the network.

In one embodiment, customers will view merchant prices and estimates online. Customers maintain service related information with the online marketplace, including past work orders, invoices, bills and payment history. Customers can compare past invoices, current warranties and coverage, payment history, service reminders, favorite merchant, merchant comments and feedback that enables better decision making.

In one embodiment, the customer profile can maintain payment information on the server. This allows a user to view a payment history, review past invoices, monthly statements, prices, etc.

In one embodiment, the customer profile can maintain purchase orders, warranties and user manuals on the server. This electronically stores the customer's purchase orders, warranties, user manuals, etc. for easy retrieval by the customer. Furthermore, the server can remind the customer to get a product checked before a warranty expires and similar reminders.

In one embodiment, the online marketplace will provide assistance to customers on pricing issues while managing merchants that undercut on pricing but providing substandard products and services. The online marketplace acts as a liaison between the customer and the merchant. Part of the oversight will be driven by the customer, through reviews and feedbacks on the services performed. Another part of the oversight will be driven by payments processing services that will be performed by the online marketplace.

Customers will receive one monthly statement and will have the option to make one monthly payment. The online marketplace will allocate and disburse the payments on behalf of the customer to the various merchants. As a result the online marketplace is in a better position to negotiate prices on behalf of the customers and may recommend merchants to follow best practices when it comes to pricing and service quality.

In one embodiment, the online marketplace includes functionality to accommodate both customer initiated and merchant initiated (with customer permission) recommendations for future appointments based on business data.

FIG. 2B illustrates an example procedure for a customer requesting an appointment in an online marketplace calendar. For example, the procedure can execute on a workstation as illustrated in FIG. 4 or a mobile device as illustrated in FIG. 5 of a system as illustrated in FIG. 1.

In 250, the workstation can test whether a customer query has been received. The customer query can include search criteria for a desired merchant. The workstation can provide a browser as discussed below, which can receive a customer query.

If a customer query has been received, the workstation proceeds to 252. If no customer query has been received, the workstation can wait at 250.

In 252, the workstation can transmit the customer query to a server over a network. One or more search results can be presented to the customer. The customer can select a merchant to view the merchant profile information.

In 254, the workstation tests whether merchant profile information is received from the server. The merchant profile information can be displayed by the workstation or mobile device to the customer for viewing.

If the merchant profile information is received, the workstation displays it and proceeds to 256. If the merchant profile information is not received, the workstation returns to 250. For example, if no suitable merchants are found, the customer may enter another customer query at 250.

In 256, the workstation transmits a customer proposed appointment to the server. The customer can decide whether the merchant is acceptable. If yes, the customer selects an appointment time based on the merchant's availability calendar and a requested service based on available services.

Various features can allow a user to select an appropriate merchant. For example, there can be an Out Bid This Job (OBTJ) Feature. This allows the customer to receive multiple quotes from similar merchants for a specific service. This would require participating merchants to present a standard pricing for specified services. Additionally, a customer can take a merchant's quote and share it on the site and have other merchants ‘Out Bid This Job’, somewhat of a Dutch auction process where the job is rewarded to the merchant not just on the lowest bid but while maintaining certain service/work quality standards.

A review functionality gives customers and merchants the opportunity to give and read reviews. Thus, the customer query can be, in part, based on the merchant's reviews. Furthermore, the merchant profile information can include prior reviews by other customers of the merchant.

A recommend alternative merchant functionality gives the customer and the merchant the ability to have a backup merchant (such as a proxy or another merchant) in the event of an emergency or cancellation. This can either be initiated by the merchant, or if the customer opts for a ‘Backup’ option this can be initiated by the server.

In 258, the workstation tests whether a confirmation has been received from the server. As discussed above, the server will send a confirmation if the merchant accepts the customer proposed appointment.

Alternatively, the merchant can counter-offer with an alternative appointment time.

In 260, the workstation exits the procedure.

In 262, the workstation displays an error message. For example, a transmission error may have prevented a confirmation from being received. Alternatively, the merchant refused to accept the customer proposed appointment.

It will be appreciated that the above functionality can be provided via a browser accessing a webpage, or via a plug in module installed on the workstation or mobile device. The plug in module can be as discussed below.

FIG. 3 illustrates an example server for providing an online marketplace calendar. For example, the server can be part of the system as illustrated in FIG. 1.

A server 300 is configured to communicate with workstations and mobile devices, as illustrated in FIG. 1. The server 300 can interact with other system components to provide online marketplace calendar functionality, discussed above.

The server 300 includes a display 302. The display 302 can be equipment that displays viewable images, graphics, and text generated by the server 300 to a server administrator. For example, the display 302 can be a cathode ray tube or a flat panel display such as a TFT LCD. The display 302 includes a display surface, circuitry to generate a viewable picture from electronic signals sent by the server 300, and an enclosure or case. The display 302 can interface with an input/output interface 308, which converts data from a central processor unit 312 to a format compatible with the display 302.

The server 300 includes one or more output devices 304. The output device 304 can be any hardware used to communicate outputs to the administrator. For example, the output device 304 can be audio speakers and printers or other devices for providing output to the administrator.

The server 300 includes one or more input devices 306. The input device 306 can be any hardware used to receive inputs from the administrator. The input device 306 can include keyboards, mouse pointer devices, microphones, scanners, video and digital cameras, etc.

The server 300 includes an input/output interface 308. The input/output interface 308 can include logic and physical ports used to connect and control peripheral devices, such as output devices 304 and input devices 306. For example, the input/output interface 308 can allow input and output devices 304 and 306 to communicate with the server 300.

The server 300 includes a network interface 310. The network interface 310 includes logic and physical ports used to connect to one or more networks. For example, the network interface 310 can accept a physical network connection and interface between the network and the server 300 by translating communications between the two. Example networks can include Ethernet, the Internet, or other physical network infrastructure.

Alternatively, the network interface 310 can be configured to interface with a wireless network. In one embodiment, the server 300 can include multiple network interfaces for interfacing with multiple networks. It will be appreciated that the server 300 can communicate over any combination of wired, wireless, or other networks.

The server 300 includes a central processing unit (CPU) 312. The CPU 312 can be an integrated circuit configured for mass-production and suited to a variety of computing applications. The CPU 312 can sit on a motherboard within the server 300 and control other workstation components. The CPU 312 can communicate with the other components via a bus, a physical interchange, or other communication channel.

The server 300 includes memory 314. The memory 314 can include volatile and non-volatile memory accessible to the CPU 312. The memory can be random access and provide fast access for graphics-related or other calculations and computations. In an alternative embodiment, the CPU 312 can include on-board cache memory for faster performance.

The server 300 includes mass storage 316. The mass storage 316 can be volatile or non-volatile storage configured to store large amounts of data. The mass storage 316 can be accessible to the CPU 312 via a bus, a physical interchange, or other communication channel. For example, the mass storage 316 can be a hard drive, a RAID array, flash memory, CD-ROMs, DVDs, HD-DVD or Blu-Ray mediums.

The server 300 communicates with a network 318 via the network interface 310. The network 318 can be as discussed above in FIG. 1.

The CPU 312 can execute an appointment module 320. The appointment module 320 can be computer-executable code for providing online calendar functionality, as discussed above. The appointment module 320 can interact with a customer over the network 318 by providing merchant profile information and receiving customer proposed appointments. The appointment module 320 can also transmit confirmation, reminder, and follow up messages to the merchant and customer.

In one embodiment, the online calendar functionality can be provided by a customer-installed plug-in. In this example, the CPU 312 can further execute an optional plug-in interface 322 for interfacing with the customer plug-in.

Alternative embodiments can include examples of server 300 e.g. distributed servers, cloud computing, virtual servers, etc. Servers are not limited to a display set, a server versus a generic or an individual system.

FIG. 4 illustrates an example workstation for providing an online marketplace calendar. A workstation 400 can be used by a user, such as a customer or a merchant, to access online calendar functionality, as illustrated in FIG. 1.

The workstation 400 can provide a user interface to a user 402. In one example, the workstation 400 can be configured to function as a user interface between the user 402 and a server 416. For example, the workstation 400 can communicate with a server as illustrated in FIG. 3.

The workstation 400 can be a computing device such as a personal computer, desktop, laptop, a personal digital assistant (PDA) or other computing device. The workstation 400 is accessible to the user 402 and provides a computing platform for executing and providing various applications.

The workstation 400 can include a display 404. The display 404 can be physical equipment that displays viewable images and text generated by the workstation 400. For example, the display 404 can be a cathode ray tube or a flat panel display such as a TFT LCD. The display 404 includes a display surface, circuitry to generate a picture from electronic signals sent by the workstation 400, and an enclosure or case. The display 404 can interface with an input/output interface 410, which forwards data from the workstation 400 to the display 404.

The workstation 400 can include one or more output devices 406. The output device 406 can be hardware used to communicate outputs to the user. For example, the output device 406 can include speakers and printers, in addition to the display 404 discussed above.

The workstation 400 can include one or more input devices 408. The input device 408 can be any computer hardware used to translate inputs received from the user 402 into data usable by the workstation 400. The input device 408 can be keyboards, mouse pointer devices, microphones, scanners, video and digital cameras, etc.

The workstation 400 includes an input/output interface 410. The input/output interface 410 can include logic and physical ports used to connect and control peripheral devices, such as output devices 406 and input devices 408. For example, the input/output interface 410 can allow input and output devices 406 and 408 to be connected to the workstation 400.

The workstation 400 includes a network interface 412. The network interface 412 includes logic and physical ports used to connect to one or more networks. For example, the network interface 412 can accept a physical network connection and interface between the network and the workstation by translating communications between the two. Example networks can include Ethernet, or other physical network infrastructure. Alternatively, the network interface 412 can be configured to interface with a wireless network. Alternatively, the workstation 400 can include multiple network interfaces for interfacing with multiple networks.

The workstation 400 communicates with a network 414 via the network interface 412. The network 414 can be any network configured to carry digital information. For example, the network 414 can be an Ethernet network, the Internet, a wireless network, a cellular data network, or any Local Area Network or Wide Area Network.

Alternatively, the workstation 400 can be a client device (i.e., thin client) in communications with the server 416 over the network 414. Thus, the workstation 400 can be configured for lower performance (and thus have a lower hardware cost) while the server 416 provides necessary processing power and resources.

The workstation 400 communicates with the server 416 via the network interface 422 and the network 414. The server 416 can be as illustrated in FIG. 3.

The workstation 400 includes a central processing unit (CPU) 418. The CPU 418 can be an integrated circuit configured for mass-production and suited for a variety of computing applications. The CPU 418 can be installed on a motherboard within the workstation 400 and control other workstation components. The CPU 418 can communicate with the other workstation components via a bus, a physical interchange, or other communication channel.

The workstation 400 includes a memory 420. The memory 420 can include volatile and non-volatile memory accessible to the CPU 418. The memory 420 can be random access and store data required by the CPU 418 to execute installed applications. In addition, the CPU 418 can include on-board cache memory for faster performance.

The workstation 400 includes mass storage 422. The mass storage 422 can be volatile or non-volatile storage configured to store large amounts of data. The mass storage 422 can be accessible to the CPU 418 via a bus, a physical interchange, or other communication channel. For example, the mass storage 422 can be a hard drive, a RAID array, flash memory, CD-ROMs, DVDs, HD-DVD or Blu-Ray mediums.

The workstation 400 can execute a browser 424 configured to function as a user interface between the user 402 and the server 416. The workstation 400 can further execute an optional plug in module 426. In one embodiment, the online calendar functionality discussed above can be provided by a plug in module 426 installed by the user 402 at the workstation 400.

FIG. 5 illustrates an example mobile device for providing an online marketplace calendar. A mobile device 500 can be accessible to a user 502 and interact with a server as illustrated in FIG. 1.

The mobile device 500 can be a cellular phone, a PDA, or a similar portable device with wireless communication capabilities accessible by the user 502. The user 502 of the mobile device 500 can be both customers and merchants.

The mobile device 500 can include a processor 504. The processor 504 can be a general purpose processor configured to execute computer-readable instructions operating the mobile device 500 and associated peripherals. It will be appreciated that any number of processors can be included in the mobile device 500, including specialized processors.

The mobile device 500 can include a location determining module 506. The module 506 can be a GPS receiver module configured to receive GPS signals and calculate a physical location of the mobile device 500 based on the received GPS signals and an internal clock time. The physical location calculation can be optimized by, for example, averaging the GPS signals over time or incorporating a signal from a known nearby location.

Alternatively, the module 506 can calculate a physical location by cellular signal triangulation, via short-range wireless network detection, or other methods.

The mobile device 500 can include a clock 508. The clock 508 can provide a local time accessible to the mobile device 500 and the user 502. The clock 508 can also provide an internal time for use with the GPS module. The clock 508 can be periodically updated from a server in communications with the mobile device 500.

The mobile device 500 includes an accelerometer 510. The accelerometer 510 can be configured to detect movements of the mobile device 500 and convert the movement into input signals transmitted to the processor 504.

The mobile device 500 includes additional sensors 512. Additional sensors can include audio input devices or optical input devices. Audio input devices can include microphones. Optical input devices can include cameras or light sensors. The sensors 512 can be configured to detect appropriate input and convert the input into input signals transmitted to the processor 502.

The mobile device 500 can include a network interface 514. For example, the network interface 514 can communicate with a cellular wireless network, a wired network such as Ethernet, or a short range wireless network such as Bluetooth or Wi-Fi. The mobile device 500 can include multiple network interfaces or a network interface configured to interface with multiple networks. Wireless network interfaces can communicate via an antenna 550.

An Ethernet network interface allows the mobile device 500 to communicate when plugged in. The mobile device 500 can be assigned an IP address on the wired network. A short-range wireless network can be a Wi-Fi, Wi-Bree or Bluetooth network.

The mobile device 500 can include an input/output interface 516. The interface 516 can receive user inputs from an input device and convert the user inputs into user commands. For example, input devices can include a touch screen display, a keypad, a microphone, an optical device, a pointer device, a scroll wheel, or other input devices.

The interface 516 can also transmit output to an output device in a form accessible to the user 502. For example, output devices can include a touch screen, a display screen, a speaker, an audio-out jack, an electro-mechanical motor for providing tactile output, or other output devices.

The mobile device 500 can include a memory 518. The memory 518 can be read-only or read-write, persistent or volatile memory accessible to the processor 504. The memory 518 can store data required by the mobile device 500 for operation and applications for execution.

The mobile device 500 can include an antenna 520. The antenna 520 can be configured to transmit and receive wireless signals from a wireless network.

The mobile device 500 can store and execute an optional plug in module 522. The plug in module 522 can provide access to the online calendaring functionality discussed above.

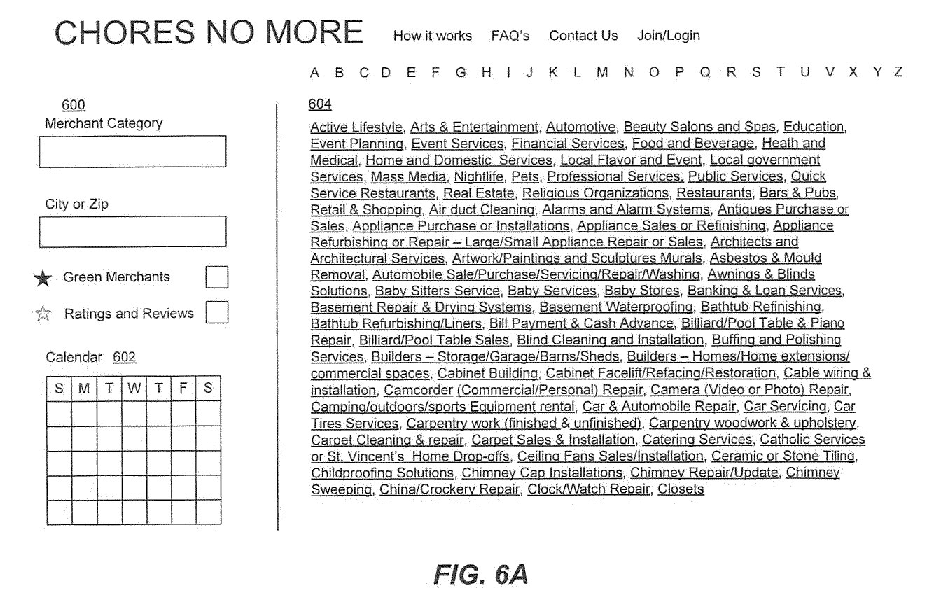

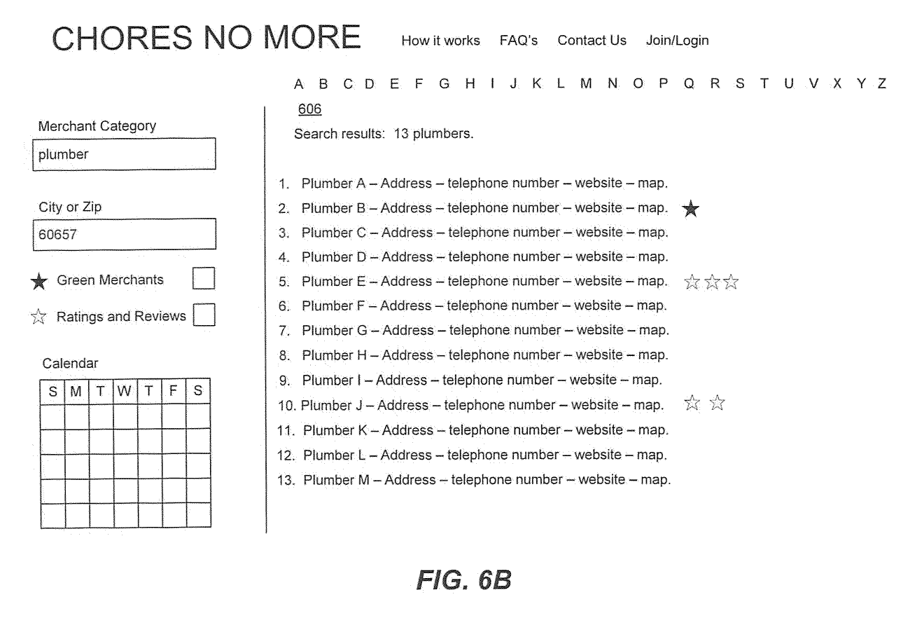

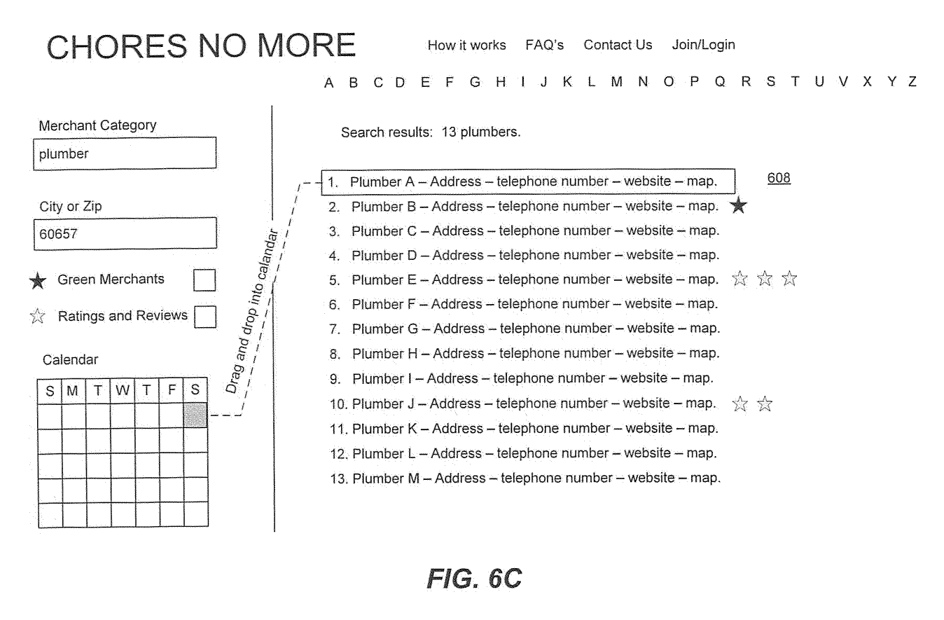

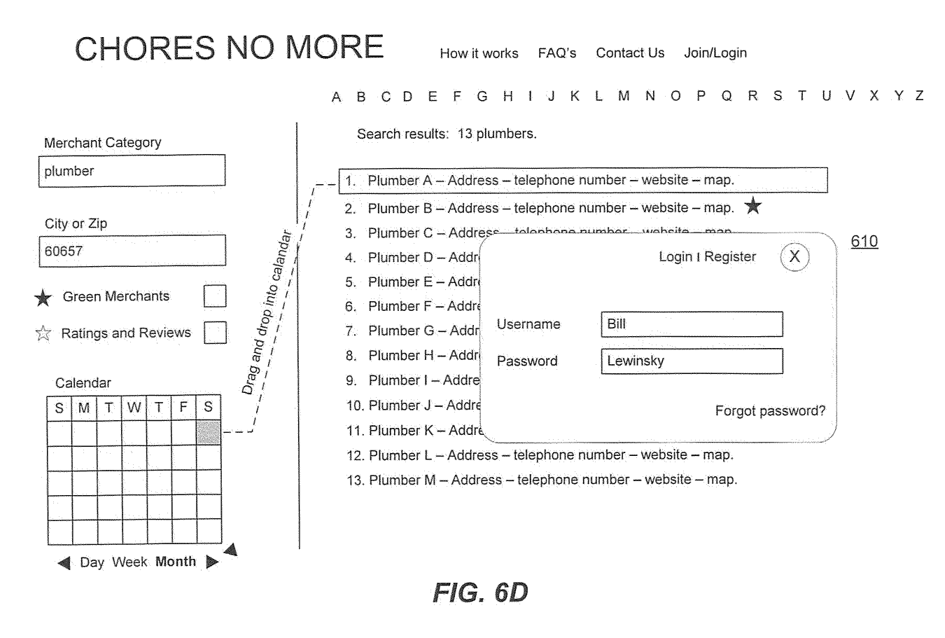

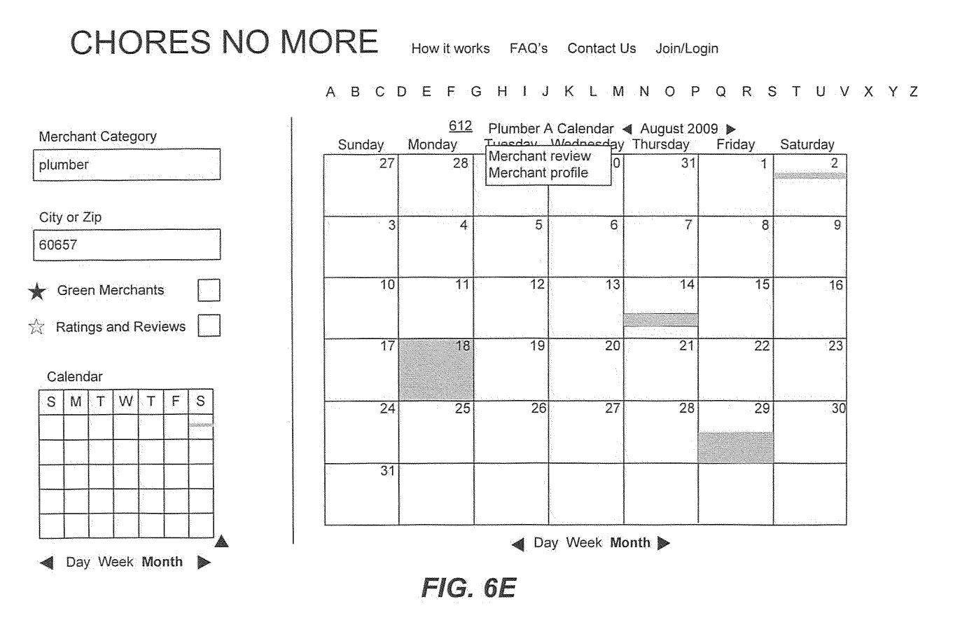

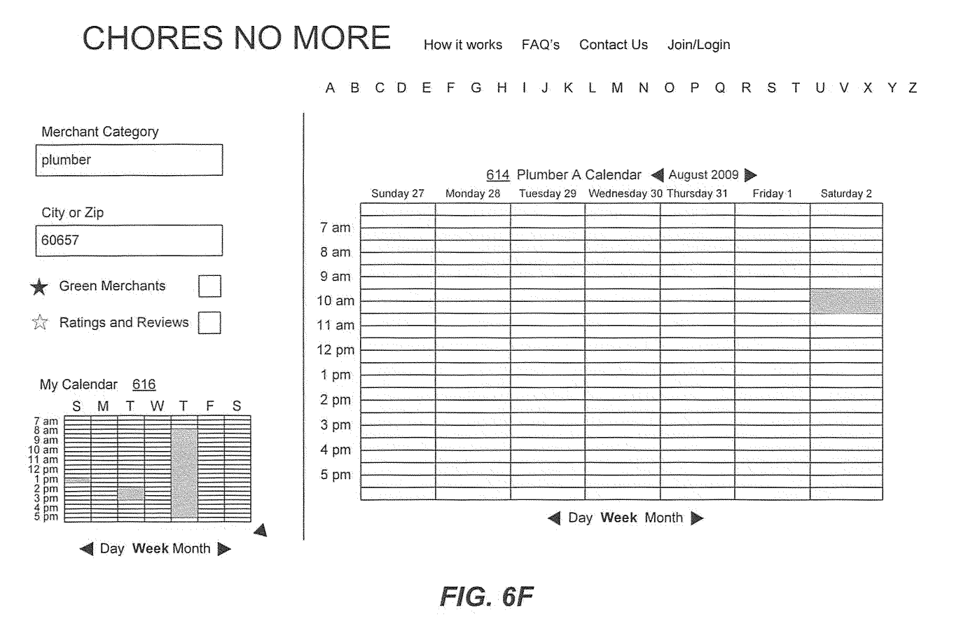

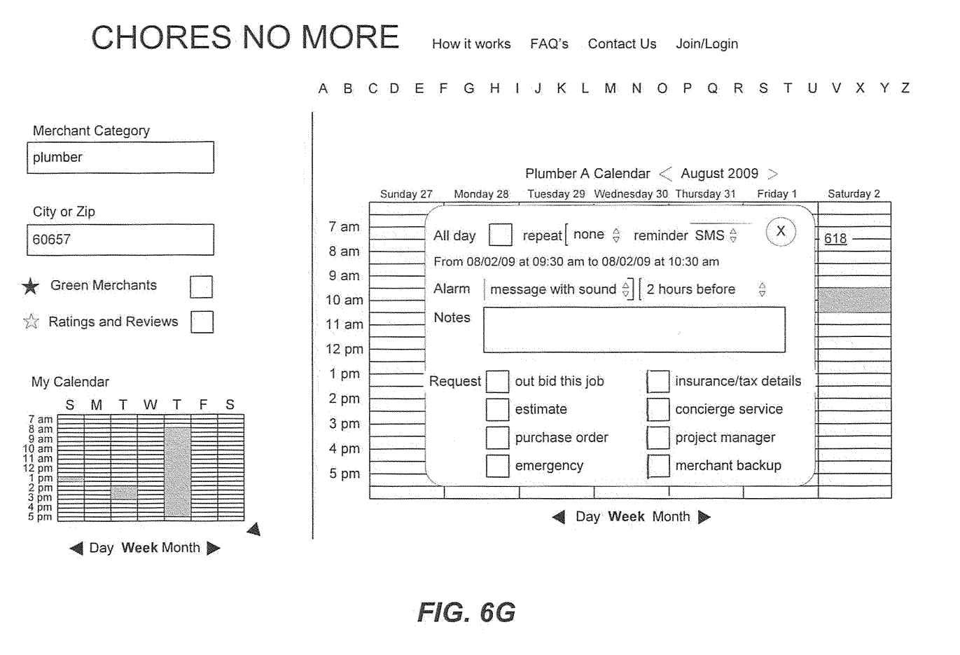

FIG. 6A illustrates a first example screen shot of a website for providing an online marketplace calendar. The first screen shot can illustrate a search page accessible to a customer.

Search criteria input fields 600 can receive customer-inputted search criteria. For example, search criteria can include a merchant category, a merchant city, a merchant zip code, a green merchant classification, and a ratings and reviews classification.

A user calendar 602 can display current appointments scheduled for a customer.

A directory 604 can list categories of merchants available for search by the customer. Example categories for merchants are discussed below. Each category can be a link to a dedicated page of merchants within the select category.

FIG. 6B illustrates a second example screen shot of a website for providing an online marketplace calendar. The second screen shot can display search results responsive to a user search initiated in the first screen shot above.

Search results 606 can be displayed responsive to a user search for a “plumber” in the zip code of “60657”, as illustrated in the screen shot. Each search result can be associated with a specific merchant, along with the merchant's address, telephone number, and website.

In additional, screen shot can provide a “map” link that will display the merchant's address on a graphical map. In addition, icons or other indicators can be used to indicate “green merchants” and a merchant's ratings and reviews. It will be appreciated that other merchant information can also be displayed.

FIG. 6C illustrates a third example screen shot of a website for providing an online marketplace calendar. The screen shot illustrates a user having selected a merchant 608. The selected merchant 608 can be dragged and dropped onto the calendar.

Alternatively, clicking on the selected merchant 608 can bring up a merchant profile information page with merchant services, availability, and information.

FIG. 6D illustrates a fourth example screen shot of a website for providing an online marketplace calendar. The screen shot illustrates a customer log-in screen 610. For example, each customer can be associated with an account on the system. By inputting a username and password pair, the customer can accesses his account on the system including his online calendar and appointments.

FIG. 6E illustrates a fifth example screen shot of a website for providing an online marketplace calendar. A merchant calendar 612 can be displayed. The calendar 612 can illustrate merchant availability over the upcoming month, allowing the customer to easily visualize when the merchant is available for an appointment. The customer can select a requested appointment time from the available times.

FIG. 6F illustrates a sixth example screen shot of a website for providing an online marketplace calendar. A merchant calendar 614 can be displayed, similar to FIG. 6E, but in a weekly view. The customer can select a requested appointment time from the available times.

FIG. 6G illustrates a seventh example screen shot of a website for providing an online marketplace calendar. The customer can request a service at a specified time from a selected merchant via a request window 618. The customer can specify a repeat appointment, a reminder to be delivered via SMS or other communication channel, and other information. The customer can further specify the nature of the request, such as an “out bid this job” (discussed above), a request for estimate, a purchase order, an emergency request, a request for insurance or tax details, a request for concierge service, a request for a project manager, or a request for a backup merchant.

An alternative embodiment can be an automobile system. For example, the online marketplace interacts with an automobile and automatically updates the user's calendar with future services or maintenances based on actual automobile usage rather than the standard 90 days or 3000 mile rule of thumb. Moreover the server helps the customer schedule an appointment based on the car manufacturer. This example embodiment includes an automated interface for interacting with the vehicle.

An alternative embodiment can be a medical appointment/records system. For example, the online marketplace interacts with medical/dental/veterinarian's and the insurance company's internal systems to inform the customer of pending checkups, based on the customer's medical records (or a pet's medical record). Insurance information can be used to help schedule an appointment, for example, insurance is expiring this month and customer need to make use of a second annually covered dental cleaning. In another example, the online marketplace can remind the customer to get a flu shot based on a time of year and predicted flu impact associated with a zip code.

An alternative embodiment can be a government agencies system. For example, the online marketplace can track city stickers, parking permits, passport renewal, property tax due dates, etc. based on a customer address and information. The online marketplace automatically determines the fee due dates and populates the customer's calendar with URL links that allow the customer to pay the taxes and fees online.

An alternative embodiment can be an events/recreational system. For example, based on a customer's zip code or areas of interest, the online marketplace will share the schedules for the different park district activities, summer camps, street festivals, art fares, private dance classes, foreign language lessons in the local area. The customer can select an event and automatically add the event to a calendar and make an appointment.

An alternative embodiment can be an education system. For example, community colleges, universities, etc. can improve enrollment and attendance by automatically populating a student's calendar with the classes. Similarly, continuing education providers can send regular reminders of relevant courses for a customer to maintain a professional license (such as an attorney or a CPA). The system can send a reminder with a link allowing the customer to schedule an appointment or enroll in a class.

An alternative embodiment can allow interaction with other calendaring systems, such as Blackberry, iCal, Outlook, Lotus Notes, Google Calendar, Yahoo Calendar, etc.

An alternative embodiment can help with identifying social, sports, political, religious etc. affiliation where the site will help flag upcoming events, holiday activities, services etc.

It will be appreciated that example categories for merchants can include: Active Lifestyle, Arts & Entertainment, Automotive, Beauty Salons and Spas, Education, Event Planning, Event Services, Financial Services, Food and Beverage, Health and Medical, Home and Domestic Services, Hotels, Travel and Entertainment, Local Flavor and Events, Local Services, Mass Media, Nightlife, Pets, Professional Services, Public Services, Quick Service Restaurants, Real Estate, Religious Organizations, Restaurants, Bars & Pubs, Retail & Shopping.

It will be appreciated that example services for merchants to provide can include: Air Duct Cleaning, Alarms and Alarm Systems, Antiques Purchase or Sales, Appliance Purchase or Installations, Appliance Sales or Refinishing, Appliance Refurbishing or Repair—Large/Small Appliance Repair or Sales, Architects and Architectural Services, Artwork/Paintings and Sculptures/Murals, Asbestos & Mould Removal, Automobile Sale/Purchase/Servicing/Repair/Washing, Awnings & Blinds Solutions, Baby Sitters Services, Baby Services, Baby Stores, Banking & Loan Services, Basement Repair & Drying Systems, Basement Waterproofing, Bathtub Refinishing, Bathtub Refurbishing/Liners, Bill Payment & Cash Advance, Billiard/Pool Table & Piano Repair, Billiard/Pool Table Sales, Blind Cleaning and Installation, Buffing & Polishing Services, Builders—Storage/Garages/Barns/Sheds, Builders—Homes/Home extensions/Commercial spaces, Cabinet Building, Cabinet Facelift/Refacing/Restoration, Cable wiring & installation, Camcorder (Commercial/Personal) Repair, Camera (Video or Photo) Repair, Camping/outdoors/sports Equipment rental, Car & Automobile Repair, Car Servicing, Car Tires Services, Carpentry work (finished & unfinished), Carpentry woodwork & upholstery, Carpet Cleaning & repair, Carpet Sales & Installation, Catering Services, Catholic Services or St. Vincent's Home Drop-offs, Ceiling Fans Sales/Installation, Ceramic or Stone Tiling, Childproofing Solutions, Chimney Cap Installation, Chimney Repair/Update, Chimney Sweeping, China/Crockery Repair, Clock/Watch Repair, Closets Installation or Repair, Closet Solutions, Computer/Laptop Repair & Services, Computer Purchase or Sales, Computer and Information Systems Training, Concrete—Pouring/Leveling, Concrete—Mud jacking/leveling & Repair, Construction (internal or External), Couch/Sofa set Reupholstering, Countertops Installation, Credit & Debt Services, Curtains Tailoring, Dental Services & Dentist, Doors Installation or repairs, Drain Pipe & Eaves Troughs Installation—Exterior/Interior, Drapery & Fabric Cleaning, Driveway Installation & repairs, Driveways—Asphalt/Brick/Cobble Stone/Concrete, Dry Cleaners/Washing & Ironing, Dryer Ventilation Cleaning and repair, Drywall installation and repair, Earthquake & Flood Retrofitting, Electric Bill payments, Electrical Solutions, Electricians, Emergency Solutions e.g. 911 Call systems (medical/security), Energy Efficiency Solutions, Epoxy Flooring or Paints, Estate/Garage/Yard/Block/Tax Sales, Estate Planning & Consulting, Event or Party Planning & Entertainment, Excavating or Boring, Eye/Vision Appointments, Family Planning Clinics, Film creation and associated staff/crew, Fireplaces procurement & installation, Firewood/coal or propane delivery, Floor Cleaning/Repair, Floor—Polishing/Waxing, Flooring—Sales/Installation, Food Bank Collections/Pickups, Foundation Work/Repair, Framing pictures or artwork preservation, Furnace Installation/maintenances/Repair, Furniture Custom Manufacturing, Furniture Refinishing or Repair, Furniture Purchase or Sale, Funeral Home Planning & Services, Garage Doors installation or repair, Garbage/Trash/Recycling Collection, Gardening/Landscaping, Gas, Gas & Heating Solutions, Gas Grill Repair, Gas Leaks Repair, Glass & Mirrors sales and installation, Glass Block installation, Groceries procurement and delivery, Gutter & Eaves troughs Cleaning, Gutter Repair/Replacement/installation, Gym Membership & Active Lifestyle Solutions, Haircut & Barber Appointments, Handyman/Repairman Service, Hardware & Home Improvement Stores/Services, Hardwood Flooring Sales, Hardwood Flooring Installation/Refinishing, Hauling or Pickup Services, Heat, Heating & A/C Systems/Solutions, Holiday Decorations and installations, Holiday Decorations rentals, Home Alarm & Security Systems, Home & Commercial Property Appraisals, Home Cleaning & Maid Services, Home & Site Inspection, Home & Office LAN Setup, Home Repairs, Home Purchases or Sales, Home Prepping/Staging, Household Items e.g. Lowes, Home Depot etc., Hurricane Boards/Film, Hurricane/Storm Shutters, Home/Heating Insulation, Insurance—Liability/Property/Life/Health/Umbrella, Interior Designing & Decorating, Internet Service & Providers, Invitations/Business/Greeting Cards, Lamp/Chandelier Repair, Lamp Shade Repair/Replacements, Landscaping/Gardening/Lawn work, Landscaping—Hard/Soft-scaping & Paving, Laundry—Pickup/Cleaning/ironing, Lead Testing, Lead removing, Legal Work, Legal Solutions, Lighting—Interior/Exterior, Limo/Taxi/Shuttle/Cab Pickups, Locksmiths & Key Solutions, Luggage Repair & Purchases, Maid & House Cleaning Service, Mailbox Repairs or Installations, Marble/Granite/Slate Purchase & Installation, Marriage & Divorce Councilor, Masonry & Brickwork, Massage & Chiropractic Services, Mattresses & Mattress Board, Meals/Restaurant/Pubs—Delivery/Reservations/take outs, Metal Fabrication, Metal Restoration, Mold/Lead/Gas Leak/Asbestos Testing & Fixing, Mortgage & Loan Brokers/Companies, Movers or Moving Services, Nails/Pedicure/Manicure Services, Newspaper/Magazine/Library Books—Delivery/pickups/drop-offs, Office Services e.g. Kinkos, Oil Change—Cars etc, Organization Services—Office/Home/Garage/storage/Closets, Package Delivery or pick-ups e.g. FedEx, UPS, USPS etc. Painting—Exterior & Interior, Pest Control, Pest Exterminating services, Pet Services, Pet Walkers, Pet Daycare, Pet Supplies—purchases/delivery, Pharmacy services, Pharmacy drop-offs, Phone Sales/repairs, Phone Service providers e.g. cell/mobile/landline/VoIP, Phone/Cable/Home Theater Wiring, Photographers—Portrait, Physician/Doctors Appointments, Piano Moving/Wring, Piano Tuning/LAN Connecting, Plastering, Plumbing work, Plumbing—Drain Cleaning/repair, Pressure Washing, Priest Appointments—Confessions/Consultations/Marriage counseling, Private Tutoring/Lessons, Propane/Gas Sales/Services, Property Management Services, Radon Gas Detection & Reduction, Recruiters/Job Placement/Career Counseling, Recycling Pickup, Remodeling—General/Kitchen/Bathroom/Patio/Enclosures, Roof repair & cleaning, Roof Ice/Snow Removal, Roof installation, Salvation Army Pickup, Screen Repairs, Seamstress/Tailoring services, Septic Tank repair and servicing, Sewer and Drain Cleaning, Sewing Services, Shoe/Heel/Umbrella/Hand Bags Repair, Siding installation and repair, Signage, Skylights installation and repair, Snow Removal services, Solar Panels installations and repairs, St Vincent Home/Catholic Services Drop-offs, Stereo & Home Theater Systems Services, Stone & Gravel procurement and delivery, Structural Engineering services, Table/Chair/tent rental services, Tax and accounting Advice, Tax Appeals—Property and Income, Taxi/Cab Service, Telephone—Mobile/Cell, Tiling procurement & instillation, Toy purchase & Repair, Travel & Entertainment Services, Tutor/Education/Coaching Services e.g. Kaplan, Rosetta Stone etc., HDTV Dish Antenna, HDTV installation & Repair, HDTV Purchases & Sales, HDTV Service—Cable, HDTV Service—Satellite, Upholstering—General & Cleaning, Utilities Management, Utility Consulting, Utility bill Payment, Vacuum Cleaner Sales & Repair, VCR/Blue Ray Repair, Veterinary Services, Voice Mail, Walk In Clinics/24 Hr Clinics e.g. Ready Care, Wallpaper Removal, Wallpaper Installation, Water & Smoke Damage Repair, Water Coolers Sale & installation, Water Delivery, Water Heaters, Water Softeners, Washer/Dryer repair/installation, Wedding/birthday Cards, Wedding & Reception Planning, Welding Services, Wells & Pumps services, Window Cleaning services, Window Tinting services, Window Treatments services, Windows procurement/instillation, Windows/Doors/Screens/Shutters, Wrought Iron furniture etc., Call Centers, Massage Therapists, Tanning Salons, Nail Salons, Medical Spas, Golf Lessons/Driving Range & Tee-Off Time, Tennis/Racquet Ball/Squash Courts, Athletic/Baseball/Soft Ball Fields, Personal Training, CPA & Tax Service, Educational Tutoring, Photographers, Classes/Seminars, Staff Scheduling, Room Scheduling, Book/Passes Reservations, Service Scheduling, Flu Shots, Driving Schools, Spinning Classes, Colleges/Universities classes and appointments, Schools/Districts—Summer programs/PTA meets/misc programs, Faculty & Staff Office Hours, Service Call Management, Sports & Workout Facilities, Gym times, Laser Hair Removal or Hair Implant, Lasik Eye surgery, Scheduling & Filing, Office & Interview Appointments, Church Events, Business Calendar, Small Business Office Scheduling, Health Clubs & Gyms, Financial/401K Advisors, Acupuncture/Holistic, Medical Office, Chiropractors, Grooming Scheduling, Hunting or Fishing Licensing & Scheduling, Fitness Trainers, Shipping/Receiving, Day Care Scheduling—Babies or Pets, Work Scheduling, Counselors, Event Calendars, Business & Career Coaches, Trade Shows & Conferences/Conventions, Salons and Spas, Tours, Wellness Programs, Rentals—Cars/Homes/Vacation Homes/Jewelry/Accessories etc

As discussed above, one embodiment of the present invention can be a server for providing an interactive calendar functionality within an online marketplace. The server includes a network interface. The server includes a memory for storing a merchant profile information. The server includes a processor in communication with the memory and the network interface. The processor is configured to, responsive to a customer query, provide the merchant profile information to a customer over the network interface, wherein the merchant profile information includes a merchant description, a set of available services, and an appointment availability. The processor is configured to, responsive to receiving a customer proposed appointment selected from the merchant profile information, forwarding the customer proposed appointment to a requested merchant over the network interface, wherein the customer proposed appointment includes an appointment time and a requested service. The processor is configured to, responsive to receiving a merchant acceptance, transmit a confirmation of an accepted appointment information to the customer and the merchant. The processor is configured to store the accepted appointment information in the memory. The processor is configured to, responsive to a predefined trigger, analyze the stored accepted appointment information and transmit a follow up message to the customer regarding appropriate related services. The customer query can be a search request and associated search parameters, and the merchant profile information is a search result responsive to the search request. The merchant profile information can be retrieved via at least one of: a web-accessible search result page and a web-accessible directory. The customer query can be received via a first webpage and the merchant profile information is displayed on a second webpage. The processor is configured to, responsive to a predefined trigger, transmit a reminder to the customer and the merchant prior to the appointment time. The processor is configured to generate an appointment event for import into a calendar application. The merchant profile information can further include customer ratings.

Another embodiment of the present invention can be a method for providing an interactive calendar functionality within an online marketplace. The method includes, responsive to a customer query, providing the merchant profile information to a customer over the network interface, wherein the merchant profile information includes a merchant description, a set of available services, and an appointment availability. The method includes, responsive to receiving a customer proposed appointment selected from the merchant profile information, forwarding the customer proposed appointment to a requested merchant over the network interface, wherein the customer proposed appointment includes an appointment time and a requested service. The method includes, responsive to receiving a merchant acceptance, transmitting a confirmation of an accepted appointment information to the customer and the merchant. The method includes storing the accepted appointment information in the memory. The method includes, responsive to a predefined trigger, analyzing the stored accepted appointment information and transmit a follow up message to the customer regarding appropriate related services. The customer query can be a search request and associated search parameters, and the merchant profile information is a search result responsive to the search request. The merchant profile information can be retrieved via at least one of: a web-accessible search result page and a web-accessible directory. The customer query can be received via a first webpage and the merchant profile information is displayed on a second webpage. The method includes, responsive to a predefined trigger, transmit a reminder to the customer and the merchant prior to the appointment time. The method includes generating an appointment event for import into a calendar application. The merchant profile information can further include customer ratings.

Another embodiment of the present invention can be a computer-readable storage medium including instructions adapted to execute a method for providing an interactive calendar functionality within an online marketplace. The method includes, responsive to a customer query, providing the merchant profile information to a customer over the network interface, wherein the merchant profile information includes a merchant description, a set of available services, and an appointment availability. The method includes, responsive to receiving a customer proposed appointment selected from the merchant profile information, forwarding the customer proposed appointment to a requested merchant over the network interface, wherein the customer proposed appointment includes an appointment time and a requested service. The method includes, responsive to receiving a merchant acceptance, transmitting a confirmation of an accepted appointment information to the customer and the merchant. The method includes storing the accepted appointment information in the memory. The method includes, responsive to a predefined trigger, analyzing the stored accepted appointment information and transmit a follow up message to the customer regarding appropriate related services. The customer query can be a search request and associated search parameters, and the merchant profile information is a search result responsive to the search request. The merchant profile information can be retrieved via at least one of: a web-accessible search result page and a web-accessible directory. The customer query can be received via a first webpage and the merchant profile information is displayed on a second webpage. The method includes, responsive to a predefined trigger, transmit a reminder to the customer and the merchant prior to the appointment time. The method includes generating an appointment event for import into a calendar application. The merchant profile information can further include customer ratings.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

Customer Rating Specification—Score Card may include but not limited to Timeliness, Work Quality, Prices & Discounts, Work Ethic, Professionalism & demeanor, Responsiveness etc.

Merchant and Customer Profile Data Specifications—some examples of data captured are Zip, merchant name, merchant category, type, types of services, date, time, reviews, telephone area codes, merchant addresses, prices & discounts, picture, videos, carbon credits, environmentally consciousness, carbon neutral, green solutions, energy efficiency, awards, hours of operations, free estimates, prior customer comments/feedback, service radius, serviced zip codes, email addresses, etc.

Appointment Data Stored/Captured Specifications—Storing information that can help identify customers, merchants, help with setting time, date, share estimates, coupons, warranties, urgency level, work order details, prices, reminders, appointments emergency contact information, backup options etc., and the data specifications aforementioned in Merchant Profile Data Specifications.

What is claimed is:

1. A server for providing an interactive calendar functionality within an online marketplace, comprising:
a network interface;
a memory for storing a merchant profile information;
a processor in communication with the memory and the network interface, the processor configured to,
responsive to a customer query, provide the merchant profile information to a customer over the network interface, wherein the merchant profile information includes a merchant description, a set of available services, and an appointment availability,
responsive to receiving a customer proposed appointment selected from the merchant profile information, forwarding the customer proposed appointment to a requested merchant over the network interface, wherein the customer proposed appointment includes an appointment time and a requested service,
responsive to receiving a merchant acceptance, transmit a confirmation of an accepted appointment information to the customer and the merchant, and
storing the accepted appointment information in the memory.

2. The server of claim 1, the processor further configured to
responsive to a predefined trigger, analyze the stored accepted appointment information and transmit a follow up message to the customer regarding appropriate related services.

3. The server of claim 1, wherein the customer query is a search request and associated search parameters, and the merchant profile information is a search result responsive to the search request.

4. The server of claim 3, wherein the merchant profile information is retrieved via at least one of: a web-accessible search result page and a web-accessible directory.

5. The server of claim 3, wherein the customer query is received via a first webpage and the merchant profile information is displayed on a second webpage.

6. The server of claim 1, wherein the processor is further configured to,
responsive to a predefined trigger, transmit a reminder to the customer and the merchant prior to the appointment time.

7. The server of claim 1, wherein the processor is further configured to,
generate an appointment event for import into a calendar application.

8. The server of claim 1, wherein the merchant profile information further includes customer ratings.

9. A method for providing an interactive calendar functionality within an online marketplace, comprising:
responsive to a customer query, providing the merchant profile information to a customer over the network interface, wherein the merchant profile information includes a merchant description, a set of available services, and an appointment availability;
responsive to receiving a customer proposed appointment selected from the merchant profile information, forwarding the customer proposed appointment to a requested merchant over the network interface, wherein the customer proposed appointment includes an appointment time and a requested service;
responsive to receiving a merchant acceptance, transmitting a confirmation of an accepted appointment information to the customer and the merchant;
storing the accepted appointment information in the memory; and
responsive to a predefined trigger, analyzing the stored accepted appointment information and transmit a follow up message to the customer regarding appropriate related services.

10. The method of claim 9, wherein the customer query is a search request and associated search parameters, and the merchant profile information is a search result responsive to the search request.

11. The method of claim 10, wherein the merchant profile information is retrieved via at least one of: a web-accessible search result page and a web-accessible directory.

12. The method of claim 10, wherein the customer query is received via a first webpage and the merchant profile information is displayed on a second webpage.

13. The method of claim 9, further comprising:
responsive to a predefined trigger, transmitting a reminder to the customer and the merchant prior to the appointment time; and
generating an appointment event for import into a calendar application.

14. The method of claim 9, wherein the merchant profile information further includes customer ratings.

15. A computer-readable storage medium including instructions adapted to execute a method for providing an interactive calendar functionality within an online marketplace, the method comprising:
responsive to a customer query, providing the merchant profile information to a customer over the network interface, wherein the merchant profile information includes a merchant description, a set of available services, and an appointment availability;
responsive to receiving a customer proposed appointment selected from the merchant profile information, forwarding the customer proposed appointment to a requested merchant over the network interface, wherein the customer proposed appointment includes an appointment time and a requested service;
responsive to receiving a merchant acceptance, transmitting a confirmation of an accepted appointment information to the customer and the merchant;
storing the accepted appointment information in the memory; and
responsive to a predefined trigger, analyzing the stored accepted appointment information and transmit a follow up message to the customer regarding appropriate related services.

16. The medium of claim 15, wherein the customer query is a search request and associated search parameters, and the merchant profile information is a search result responsive to the search request.

17. The medium of claim 16, wherein the merchant profile information is retrieved via at least one of: a web-accessible search result page and a web-accessible directory.

18. The medium of claim 16, wherein the customer query is received via a first webpage and the merchant profile information is displayed on a second webpage.

19. The medium of claim 15, the method further comprising:
responsive to a predefined trigger, transmitting a reminder to the customer and the merchant prior to the appointment time; and
generating an appointment event for import into a calendar application.

20. The medium of claim 15, wherein the merchant profile information further includes customer ratings.
